(19) United States
(12) Patent Application Publication
(10) Pub. No.: US 2011/0139082 A1
(43) Pub. Date: Jun. 16, 2011

(54) UNIQUE PET MAT

(76) Inventor: Larry Eugene Blagden, Prairie du Sac, WI (US)

(21) Appl. No.: 12/639,163

(22) Filed: Dec. 16, 2009

(51) Int. Cl. A01K 29/00

(52) U.S. Cl. 119/171

(57) ABSTRACT

A pad for pet excretion having a liquid permeable top sheet, a liquid impermeable rear sheet, and a liquid absorbent material located between the top sheet and the rear sheet. The pad is scented on its top surface, or in a region at the center of the pad, along an edge of the pad, or at a corner of the pad. The scent on the pad is detectable only by a dog and is undetectable by a human. The scent can be of a level that only a dog can detect or a scent which, regardless of its level, can be detected only by a dog and not by a human.

### BACKGROUND OF THE INVENTION

1. Field of the Invention

The present invention relates generally to absorbent pads and more specifically to disposable absorbent pads for receiving excrements from a dog.

2. Description of Related Art

Many pet owners, especially those who have pet dogs leave their pets in their house or apartment for extended periods of time while they are at work. It is not uncommon that a pet may be left alone in an apartment or house for eleven or more hours. To accommodate the excretion needs of the dog during this time, a person will usually provide a litter box for the dog to use. Most liter boxes are filled with an absorbent material for receiving the dog's excretion of solid and liquid wastes. The solid wastes must be frequently removed from the litter box for sanitary reasons and to prevent unpleasant odors. The litter, with the liquid wastes is changed periodically for hygienic reasons or when it becomes soiled. In addition to being heavy, there are a number of problems associated with litter boxes some of which are that they are unsightly, they can have unpleasant odors, and they may be messy as a result of the absorbent material being tracked or kicked out of the litter box by the dog when he/she scratches with hind legs after using the liter box. Another problem can occur when the material in the box spills out onto the floor as it is being replaced.

In addition to the problems noted above, it is not convenient to carry a litter box and the material that goes into the litter box when a pet owner travels to a distant place and stays in a hotel or motel with his/her pet dog.

Many pet owners have solved the above noted problems by replacing the litter box with a disposable absorbent pad. Absorbent pads that are useful when a dog is left indoors for an extended interval of time are disclosed, for example, in
U.S. Pat. No. 7,249,570
Inventor: Jermaine C. Roberson
Issued: Jul. 31, 2007

Apparatus for a pet training pad having a plurality of material layers to retain fluids and solid material; while preventing passage therethrough. The top layer serves as the absorbent material with the bottom layer forming a fluid impermeable layer to prevent passage of liquids. The impermeable layer extends over the periphery edge of the top absorbent layer forming a hem that is colored green to simulate grass. On the underside of the bottom layer a plurality of adhesive or frictional members are fastened thereto that will prevent movement, in whole or in part, from the selective placement of the pad. Optionally, a fragrance layer can be incorporated into the pad between the fluid impermeable base layer and the top absorbent layer to attract pets to the pad.
U.S. Pat. No. 6,550,423
Inventor: Susan Crawford Pope
Issued: Apr. 22, 2003

An absorbent dog waste disposal pad holder lacking an underlying bottom wall and having nestable upper and lower frames that cooperate to form a peripheral wall to securely hold the periphery of a disposable, absorbent pad therebetween. Each nestable upper and lower frame comprises first and second frame members. The first and second frame members of the lower frame preferably comprise opposite side ends that interlock to form the lower frame. The first and second frame members of the upper frame preferably comprise ends that abut to form the upper frame. Preferably, the frames of the absorbent dog waste disposal pad holder are generally rectangular shaped, are made of moldable polymeric material and have an inverted U-shaped cross section. A method of assembling the subject absorbent dog waste disposal pad holder is also disclosed.
U.S. Pat. No. 6,244,216
Inventor: Kengo Ochi
Issued: Jun. 12, 2001

A sheet for pet excretion including a liquid permeable front face sheet, a liquid impermeable rear face sheet and an absorbent body interposed between the front face sheet and the rear face sheet. A liquid absorbent region where the absorbent body exists has a colored portion positioned at the center thereof and a non-colored portion adjoining the colored portion so as to enclose a whole periphery of the colored portion.
U.S. Pat. No. 5,630,376
Inventor: Kengo Ochi
Issued: May 20, 1997

An absorbent composite panel comprising a liquid-absorbent panel and a liquid-impermeable backsheet, wherein the top surface of the absorbent panel is partially covered along its peripheral edges with a liquid-impermeable overflow barrier strips which are then bonded integrally to the backsheet along their outer side edges and each inner side edge of the overflow barrier strips is spaced by each spacer from the top surface of the absorbent panel by a desired distance

### SUMMARY OF THE INVENTION

In an exemplary embodiment of the present invention, there is disclosed a pad for pet excretion having a liquid permeable top sheet, a liquid impermeable rear sheet, and a liquid absorbent material located between the top sheet and the rear sheet. The pad is scented on its top surface, or in a region at the center of the pad, along an edge of the pad, or at a corner of the pad. The scent on the pad is detectable only by a dog and is undetectable by a human. The scent can be of a level that only a dog can detect or a scent which, regardless of its level, can be detected only by a dog and not by a human.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings.

FIG. 1 is a perspective view of a dog using an absorbent pad located on the floor in accordance with the principles of the invention; and

FIG. 2 is a top partial cut away view of the absorbent pad in accordance with the principles of the invention.

### DESCRIPTION OF THE PREFERRED EMBODIMENT

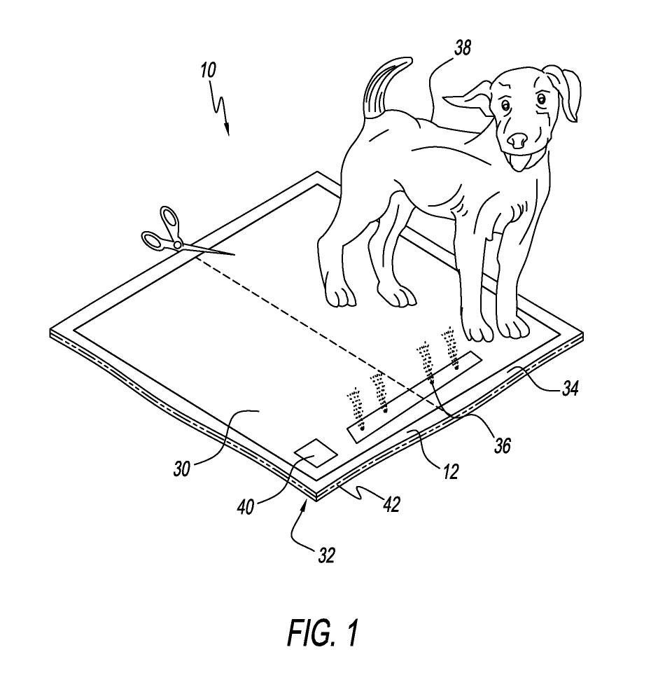

Referring to FIG. 1, there is shown a view of the absorbent pad of the invention being used by a dog. The pad 10 is an absorbent pad of flexible material 30 which may have a releasable adhesive 32 on the bottom surface which is provided to removably attach the pad to the floor of a living area.

The releasable adhesive can be on the four corners of the pad or it can be located along the perimeter of the pad. The removable adhesive prevents the pad from being moved along the floor when the dog scratches on the pad with his hind feet after using the pad. Located around the periphery on the top of the pad is a raised portion 34 having an outer impermeable layer covering liquid permeable and absorbent material.

The pad is scented across its top surface or a region 36 of the pad is scented to attract a dog 38. The scent is of a type an/or intensity level that is detectable only by dogs.

The scent is undetectable by humans. It is known that dogs can detect scents that cannot be detected by humans.

Therefore, by using a scent that only a dog can detect but is undetectable to humans, the pad can be used in a living area without adding any detectable scents to the air in the living area of the pet owner.

In use, the dog is trained to stand on the pad with all four feet when using the pad. In one embodiment a region 36 which is located adjacent to an edge of the pad is scented and this edge is placed against a wall. The dog is now trained to locate and face the scented region 36. This position of the dog insures that the rear end of the dog is on the pad and that the fluid and solid waste of the dog will fall on the pad and not on the floor. In another embodiment the region 40 can be located at a corner 42 of the pad and the corner 42 of the pad is placed against a corner of a room. Again, the dog is trained to locate the scented region 40 and this position of the dog insures that the rear end of the dog is on the pad and that the fluid and solid waste of the dog will fall on the pad and not on the floor.

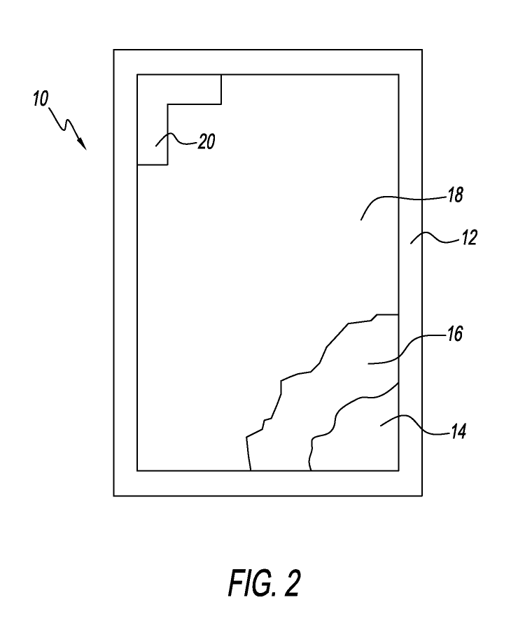

Referring to FIG. 2, there is shown a top partial cut away view of the absorbent pad in accordance with the principles of the invention. The bottom or rear sheet 14 of the pad is made of liquid impermeable material such as polyethylene, vinyl or the like which can be two feet by two feet more or less. Located immediately above the rear sheet 14 is a layer of liquid absorbent material 16 such as absorbent polymers, absorbent paper, crushed pulp, etc. An example of an absorbent polymer is a cross linked compound of sodium polyacrylate, a graft copolymer of starch with sodium polyacrylate or a graft copolymer of cellulose having polyacrylonitrile chains. Located on top of the liquid absorbent material 16 is a sheet of liquid permeable material 18 such as absorbent paper or the like.

Located on the top surface of the pad, in a central area of the pad, along an edge of the pad, or at a corner of pad 10 is region 20 which is impregnated with a distinctive scent which can be detected only by a dog but is undetectable by a human. It is known that dogs have a keen sense of smell that is more sensitive than that of humans. Therefore, a scent that can be easily detected by a dog but can not be detected by a human is used in this invention to direct a dog to the pad when it is time for the dog to eliminate. The scent can be of a level that only a dog can detect or a scent which, regardless of its level can be detected only by a dog and not by a human. The area that contains the scent should be such that the dog's behind is located above the pad when his/her nose is proximate to where the scented region is located. Thus, in an embodiment, if the pad is to be placed near a wall, region 20 can be located along the edge of the pad that is positioned next to the wall. In another embodiment, if the pad is to be located at a corner of a room, region 20 can be located at a corner of the pad. The scent can be placed in the liquid absorbent material 16 or in the liquid permeable material 18.

The pad disclosed is used in place of a litter box. When the pad is positioned in a room at a desired position, the pet owner trains the dog to position himself over the pad 10 with his nose at the scent region 20. When the dog is properly positioned, all droppings will fall on the absorbent pad. At some time after the pet has used the pad, the pet owner can replace the used pad with a new pad, roll up the used pad and place it in a garbage bag for disposal.

The pet pad is easy to carry, is sanitary, light weight, can be used in a hotel or motel room, and has a scent that is not detectable by humans.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A pad for pet excretion comprising:
a liquid permeable top sheet;
a liquid impermeable rear sheet; and
a liquid absorbent material located between said top sheet and said rear sheet;
wherein a region on the pad has a scent that is detectable by a dog and is undetectable by a human.

2. The pad of claim 1 wherein said region is located near an edge of said pad.

3. The pad of claim 1 wherein said region is located at a corner of said pad.

4. The pad of claim 1 wherein excrements from a dog will fall on the pad when the dog's nose is proximate to the region on the pad that has the scent.

5. The pad of claim 1 wherein said pad is disposable.

6. The pad of claim 1 wherein said pad can be cut to provide at least two pads.

7. The pad of claim 1 wherein said region is colored.

8. The pad of claim 1 wherein said liquid impermeable rear sheet has a releasable adhesive that can detachably attach the pad to a floor.

9. The pad of claim 2 wherein excrements from a dog will fall on the pad when the dog's nose is proximate the region on the pad that has the scent.

10. The pad of claim 3 wherein excrements from a dog will fall on the pad when the dog's nose is proximate to the region on the pad that has the scent.

11. The pad of claim 1 wherein said pad can be folded.
